(19) United States
(12) Patent Application Publication
(10) Pub. No.: US 2024/0419247 A1
(43) Pub. Date: Dec. 19, 2024

(54) METHODS AND SYSTEMS FOR PERFORMANCE IMPROVEMENT

(71) Applicant: Cheng QIAN, Weston, FL (US)

(72) Inventor: Cheng QIAN, Weston, FL (US)

(21) Appl. No.: 18/743,064

(22) Filed: Jun. 13, 2024

Related U.S. Application Data
(60) Provisional application No. 63/508,261, filed on Jun. 14, 2023.

(51) Int. Cl. G06F 3/01; G06F 3/16

(52) U.S. Cl. CPC G06F 3/015; G06F 3/013; G06F 3/167; G06F 2203/011

(57) ABSTRACT

The present disclosure relates to systems, methods, and devices that are configured to improve individual performance. Bioelectrical signal acquisition devices are used to measure and record bioelectrical signals from a user's head before and/or during the user performs certain tasks. Such signals are used to build individual performance improvement (IPI) models that can provide desired or undesired values or ranges for certain parameters. By reminding, alerting, and/or prompting the user after matching the user's bioelectrical signals with such values and ranges, the systems, methods, and devices of the present disclosure can improve the performance of the user.

### CROSS-REFERENCE TO RELATED APPLICATIONS

This application claims priority to U.S. Provisional Patent Application No. 63/508,261, filed on Jun. 14, 2023, the entire contents of which are hereby incorporated by reference.

### TECHNICAL FIELD

The present disclosure relates to systems, methods, and devices that can be used in improving, enhancing, modulating, and/or sustaining performance of tasks through bioelectrical signal recording and analysis, and human-computer interactions. Specifically, the systems, methods, and devices of the present disclosure relate to individualized performance improvement (IPI) by using an IPI model, which is established and perfected by analyzing and calibrating performance data and bioelectrical signals from an individual user.

### BACKGROUND

People are required to perform various tasks every day, and enhancing performance is crucial for both personal and organizational success. However, much of this performance relies on an individual's mental state, which is challenging to monitor, change, maintain, or improve.

Bioelectrical signals generated by biological users can be collected and processed. Typical examples of these signals include electroencephalogram (EEG), electromyogram (EMG), and electrooculogram (EOG). Some of these signals, and the patterns they form, can reflect a user's mental state. However, there is a lack of studies focusing on improving individualized performance through the recording, analyzing, maintaining, and/or modifying of bioelectrical signals, i.e., the user's mental state.

Therefore, it is desirable to develop systems, methods, and devices that utilize the bioelectrical signals through human-computer interactions to improve individualized performance.

### SUMMARY

In one aspect, the present disclosure relates to a method of individualized performance improvement (IPI) using an interactive system that includes a computational unit and a bioelectrical signal acquisition device, the method comprising: (a) recording a batch of bioelectrical signals from a user's head using the bioelectrical signal acquisition device before and/or during the user performs a first task, (b) identifying a tag associated with the batch of bioelectrical signals, wherein the tag includes a tag value corresponding to a success level of the first task; (c) repeating steps (a) and (b) multiple times to collect multiple batches of digital bioelectrical signals and a plurality of tag values; (d) processing the multiple batches of bioelectrical signals with the computational unit to identify at least one target parameter that has a parameter value and collect a plurality of parameter values, each tag value corresponding to a parameter value of a same performance by the user; (e) obtaining an IPI model tailored for the user based on the plurality of tag values and the plurality of parameter values; and (f) providing a signal sequence to the user, the signal sequence reminding the user to attempt to adjust the target parameter to a target value or a target range before performing the first task again, wherein the target value or the target range is determined by the IPI model.

In some embodiments of the present disclosure, identifying the tag comprises receiving a tagging signal provided by the user with the bioelectrical signal acquisition device or by an observer other than the user, and identifying the tag based on the tagging signal. In certain embodiments, the tagging signal includes ocular event-related potentials (o-ERPs) that are processed by the computational unit, the o-ERPs indicates the tag value. In certain embodiments, the o-ERPs are generated by the user voluntarily with eye blink, eye movement, or eyelid squeezing, or a combination thereof. Alternatively, in some embodiments, the tagging signal includes a verbal signal from the user. In certain embodiments, tagging signal includes an input at the computational unit from the user or an observer other than the user. In certain embodiments, the input is made through an interface of an application associated with the bioelectrical signal acquisition device.

In some embodiments of the present disclosure, wherein the tag value is hit or miss, in or out, on point or not on point, or in rang or not in range, desired performance or undesired performance. In some embodiments, the tag value is desired mental state, undesired mental state, calm, alerted, distracted, overthinking, mind-wandering, stressed, anxious, fatigue, bored, or excited.

Another aspect of the present disclosure relates to identifying at least one target parameter that includes alpha, beta, delta, theta, or SMR (sensory-motor rhythm) activity of the user's brain. In some embodiments, the at least one target parameter includes two or more of alpha, beta, delta, theta, or SMR activity of the user's brain.

In some embodiments of the present disclosure, the method may further comprise measuring and recording current bioelectrical signals with the bioelectrical signal acquisition device before the user performs the first task again. In some embodiments, the method may further comprise analyzing the current bioelectrical signals to obtain a current parameter value of the at least target parameter and matching the current parameter value with the target parameter value or the target parameter range of the target parameter.

In some embodiments of the present disclosure, the signal sequence includes an audio signal, a visual signal, or a haptic signal, or a combination thereof.

In some embodiments of the present disclosure, identifying the at least one target parameter comprises: extracting and analyzing a plurality of candidate parameters associated with the digital bioelectrical signals, each candidate parameter has a parameter value for each performance; electing the target parameter from the plurality of candidate parameters based on the analysis, wherein the target parameter's parameter values demonstrate distinct distributions for different tag values.

Yet another aspect of the present disclosure relates to a method of individualized performance improvement (IPI) using an interactive system that includes a computational unit and a bioelectrical signal acquisition device, the method comprising: (a) measuring and recording current bioelectrical signals from a user's head with the bioelectrical signal acquisition device before and/or during the user performs a first task; (b) analyzing the current bioelectrical signals to obtain a current parameter value of at least one target parameter; and (c) matching the current parameter value with a target value or a target range of the target parameter, wherein the target parameter value or the target parameter range is determined by an IPI model, which is based on multiple previous performances of the first task by the same user; and (d) upon a determination that the current parameter value does not match with the target value or the target range, providing a signal sequence to the user, the signal sequence reminding the user to attempt to adjust the target parameter to the target value or the target range before performing the first task.

In some embodiments of the present disclosure, each of the multiple previous performances of the first task generates a tag value that indicates a success level of the performance and a parameter value of the target parameter, and the IPI model is based on tag values and parameter values from the multiple previous performances. In some embodiments, the IPI model is a machine learning model.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The systems, methods, devices, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 shows a schematic diagram illustrating a human-computer interactive system, in which an exemplary bioelectrical signal acquisition device is being worn on a user's head.

FIG. 2 is a flowchart illustrating an exemplary process for individualized performance improvement (IPI), focusing on signal recording and analysis, according to some embodiments of the present disclosure.

FIG. 3 is a flowchart illustrating an exemplary process for individualized performance improvement, focusing on identifying a target parameter and obtaining an IPI model, according to some embodiments of the present disclosure.

FIG. 4 is a flowchart illustrating an exemplary process for individualized performance improvement, focusing on using an IPI model to communicate with the user, according to some embodiments of the present disclosure.

FIGS. 5A, 5B, and 5C are flowcharts illustrating exemplary processes for individualized performance improvement in sports according to some embodiments of the present disclosure.

FIG. 6 is a flowchart illustrating exemplary processes for individualized performance improvement in a mentally intensive task according to some embodiments of the present disclosure.

FIG. 7 is a flowchart illustrating exemplary processes for individualized performance improvement for a person with a mental condition according to some embodiments of the present disclosure.

FIG. 8A shows a smart phone interface (left panel) and a 1-dimensional chart (right panel) demonstrating the process of accumulation of “hit-or-miss” data points, wherein the smart phone interface includes buttons that allow the user to choose hit or miss, and the chart illustrates grouped data points; FIG. 8B shows similar hit-or-miss scenarios but in a 2-dimensional chart.

FIG. 9A shows an example of using statistical method to identify useful differentiating factors (target parameters) for hit or miss performances; FIG. 9B provides an example for identifying multiple parameters that might be responsible for hit or miss, as well as possible transition from an undesired mind state (miss) to a desired mind state (hit) with audio neurofeedback interventions (a signal sequence); FIG. 9C includes examples of EEG parameters using hexagon presentations and template matching for instant evaluation and feedback; FIG. 9D provides an example for tiered template notification system.

### DETAILED DESCRIPTION

In the following detailed description, numerous specific details are set forth by way of examples in order to provide a thorough understanding of the relevant teachings. However, it should be apparent to those skilled in the art that the present disclosure may be practiced without such details. In other instances, well known methods, procedures, systems, components, and/or circuitry have been described at a relatively high level, without detail, in order to avoid unnecessarily obscuring aspects of the present disclosure.

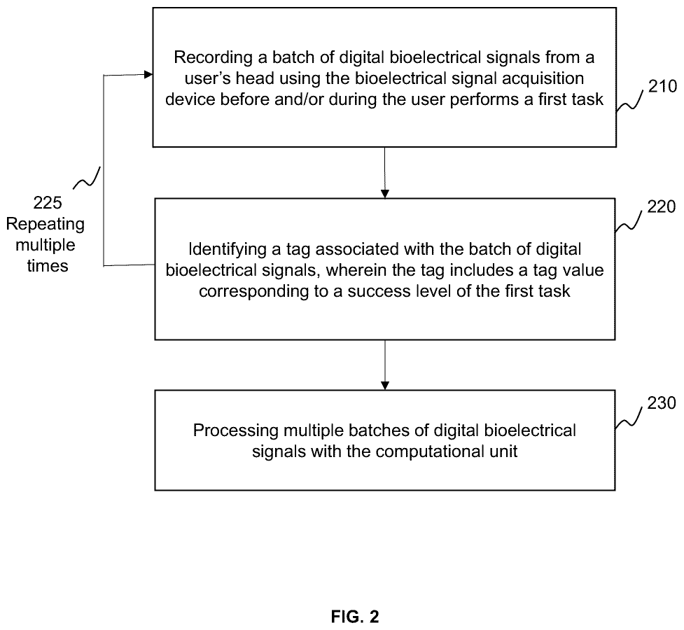

In addition, in the following detailed description, certain features are set forth when describing each group of embodiments (e.g., for embodiments associated with a particular Figure). However, it should be noted that such descriptions are not supposed to be limiting. Whenever reasonable to a person skilled in the art in view of the totality of the present disclosure, the description for certain features provided for some embodiments could be applied to other embodiments. The omission of such descriptions for the other embodiments are mostly due to the need to avoid redundancy. For example, when likely approaches are described for collecting, processing, and recording bioelectrical signals for the embodiments associated with FIG. 2, it would be reasonably understood by a person skilled in the art that such approaches would also be applicable to other embodiments of the present disclosure. There are many instances like this in the present disclosure.

The IPI systems and methods of the present disclosure may be used to enhance various types of performance. These include, but are not limited to, athletic performance in sports such as golf, baseball, basketball, soccer, and tennis; mentally intensive activities such as but not limited to taking an exam, solving complex mathematical problems, and engaging in strategic planning; and tasks performed by individuals with mental conditions, such as managing panic attacks, overcoming social anxiety during public speaking, and improving focus in individuals with ADHD. Additionally, these systems and methods can aid in creative pursuits like writing and artistic endeavors, or in high-pressure professional environments, such as trading on the stock market or performing surgeries.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood that the operations of the flowchart may be implemented not in order. Conversely, the operations may be implemented in inverted order, or simultaneously. Moreover, one or more other operations may be added to the flowcharts. One or more operations may be removed from the flowcharts.

In the present disclosure, the term “bioelectrical signal” refers to electric signals produced by biological beings, such as but not limited to plants and animals. In some embodiments, the bioelectrical signals of the present disclosure are produced by a human.

In the present disclosure, the term “user” refers to a living being that uses, wears, or is monitored by the bioelectrical signal acquisition device and/or the interactive system of the present disclosure. Here “using” means wearing and/or being tested, monitored or analyzed. In some embodiments, the user is a human being. In some embodiments, the user is an animal other than a human being. In some embodiments, the bioelectrical signal acquisition device is configured to be worn on the user's head. In some embodiments, the user is a male or a female. In some embodiments, the user is a newborn, an infant, a toddler, a child, a teenager, a young adult, an adult, or a senior.

In the present disclosure, the term “sport” refers to any physical activity or game that is characterized by a set of rules or customs and often engaged in competitively. This includes, but is not limited to, individual sports such as golf, tennis, and swimming, as well as team sports like soccer, basketball, and baseball. Sports require not only physical exertion and skill, but also particular mental states, depending on the specific sport type and performance therein required.

In the present disclosure, the phrase “mentally intensive task/activity” refers to any activity that requires significant cognitive effort, focus, and mental acuity. Examples include but are not limited to academic endeavors such as taking exams, solving complex mathematical problems, and engaging in strategic planning. These tasks can also encompass professional activities such like but not limited to conducting detailed financial analysis, performing surgeries, trading on the stock market, and legal strategizing. Additionally, mentally intensive tasks may involve creative pursuits such as writing, composing music, and artistic creation, where high levels of concentration and mental engagement are essential.

In the present disclosure, the phrase “creative endeavor” refers to any activity that involves the use of imagination, originality, and expressive skills to produce something new or to solve problems in innovative ways. This includes, but is not limited to, artistic pursuits such as writing, painting, composing music, and designing. Creative endeavors also encompass activities like inventing, crafting, and developing new technologies or solutions. These tasks require significant cognitive engagement, originality, and often a deep focus, allowing individuals to explore and express unique ideas and perspectives.

In the present disclosure, the phrase “mental state” refers to the current condition of an individual's cognitive and emotional functioning, which influences their thoughts, feelings, and behaviors. This includes levels of alertness, stress, concentration, mood, and overall mental well-being. Accordingly, exemplary mental states include but are not limited to being: alerted, calm, focused, relaxed, excited, distracted, overthinking, absent-minded, fatigued, bored, anxious, stressed, immersed, or any combination thereof. Mental state is often reflected in bioelectrical signals such as electroencephalogram (EEG), electromyogram (EMG), and electrooculogram (EOG) readings. In the context of the present disclosure, mental state plays a critical role in determining and enhancing individualized performance through the analysis and optimization of these bioelectrical signals.

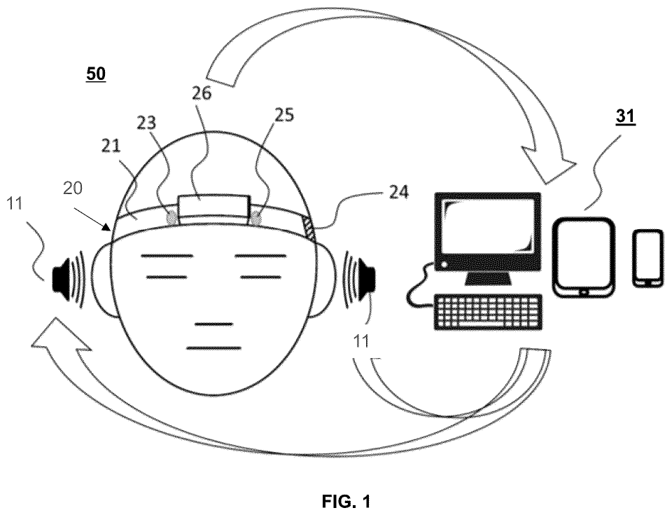

FIG. 1 shows a schematic diagram illustrating a human-computer interactive system 50 according to certain embodiments of the present disclosure, in which an exemplary bioelectrical signal acquisition device 20 is being worn on a user's head. In some embodiments, the interactive system 50 comprises a bioelectrical signal acquisition device 20 and a computational device 31. The bioelectrical signal acquisition device 20 is communicable with the computational device 31, which is configured to process the signals collected by the bioelectrical signal acquisition device 20 and provide signals in one or more forms to the user. In the following descriptions related to the IPI processes of the present disclosure, the interactive system 50, the computational device 31, and the bioelectrical signal acquisition device 20 are used to exemplary equipment to illustrate the process.

In some embodiments, the interactive system 50 and the bioelectrical signal acquisition device 20 may be the same as or similar to such systems and devices disclosed in US Pro. App. 62/695,542, filed on Jul. 9, 2018, and U.S. patent application Ser. No. 16/505,481 (now U.S. Pat. No. 11,457,860), filed on Jul. 8, 2019, the contents of which are incorporated by reference in their entireties.

In some embodiments, the interactive system 50 is used to collect, monitor, process, analyze, and/or transmit bioelectric signals from a user (e.g., human user). In some embodiments, the interactive system 50 is used to interact with the user. In some embodiments, the interactive system 50 is used to influence and/or modulate a mental state of the user. In some embodiments, the user is a user using the bioelectrical signal acquisition device 20. In some embodiments, the interactive system 50 includes the bioelectrical signal acquisition device 20 and the computational unit 31, wherein a notice unit 11 can be considered part of the computational unit 31, can be considered part of the bioelectrical signal acquisition device 20, or can be an independent or separate structure.

As shown in FIG. 1, the interactive system 50 may include a bioelectrical signal acquisition device 20, which may include components such as a headband 21, a processing unit 26, one or more recording electrodes 23 and 25, and one or more reference electrodes 24.

As shown in FIG. 1, the interactive system 50 may include a computational unit 31, which may be configured to receive the digital bioelectrical signals from the bioelectrical signal acquisition device 20. The computational unit 31 may be any part, component, processor, board, device, apparatus or system that have computational and processing capabilities. In some embodiments, the computational unit 31 includes a generic microprocessor. In some embodiments, the computational unit 31 includes a specialized microprocessor. In some embodiments, the computational unit 31 includes part or all of an integrated computing device, such as but not limited to a desk top computer, a laptop computer, a tablet, and a smart phone.

In some embodiments, the computational unit 31 is configured to process and analyze the digital bioelectrical signals provided by the bioelectrical signal acquisition device 20. In some embodiments, the computational unit 31 is configured to generate instructions and/or feedback to the bioelectrical signal acquisition device 20 based on pre-determined programs and the digital bioelectrical signals provided by the bioelectrical signal acquisition device 20. In some embodiments, the computational unit 31 is configured to generate instructions and/or feedback to a notice unit 11 based on pre-determined programs, such as but not limited to an IPI model. In some embodiments, the computational unit 31 is configured to generate instructions and/or feedback to the notice unit 11 based on pre-determined programs and the digital bioelectrical signals provided by the bioelectrical signal acquisition device 20.

As shown in FIG. 1, according to some embodiments of the present disclosure, the interactive system 50 may include a notice unit 11, which is configured to facilitate interaction with the user. For example, the notice unit 11 may be used to send and/or receive signals to and/or from the user. Such signals may include but not be limited to: visual signals, auditory, or sound-based signals; chemical signals (e.g., with perfume or pheromones), and tactile, or touch-based signals, or any combination thereof. In some embodiments, the user is a human user using the bioelectrical signal acquisition device 20.

In some embodiments, the notice unit 11 may be configured to receive instructions from the bioelectrical signal acquisition device 20 and/or the computational unit 31 to send signals to the user. In certain embodiments, the notice unit 11 includes a visual medium (e.g., a screen or a piece of paper) that is configured to present visual signals to the user. In certain embodiments, the notice unit 11 includes a tactile device that can send touch-based signals (e.g., vibration) to the user. In certain embodiments, the notice unit 11 includes an audio device (in such cases the notice unit 11 may be considered an audio unit) configured to send audio signals (i.e., play audio) to the user.

In some embodiments, the bioelectrical signal acquisition device 20, the computational unit 31, and the notice unit 11 are physically separate devices. For example, the computational unit 31 can be a desk computer, the notice unit 11 can be one or more speakers, and the bioelectrical signal acquisition device 20 can be a separate device wearable by the user. In some embodiments, the bioelectrical signal acquisition device 20 and the computational unit 31 are integrated together, while the notice unit 11 is a physically separate device. For example, the computational unit 31 can be a microprocessor integrated into the bioelectrical signal acquisition device 20, e.g., combined with a processing unit 26 of the bioelectrical signal acquisition device 20. In some embodiments, the computational unit 31 and the notice unit 11 are integrated together, while the bioelectrical signal acquisition device 20 is a physically separate device. For example, the computational unit 31 can be a smart phone or tablet, and the notice unit 11 may be the audio and/or display part of the smart phone or tablet, and the bioelectrical signal acquisition device 20 can be a separate device. In some embodiments, the bioelectrical signal acquisition device 20 and the notice unit 11 are integrated together, while the computational unit 31 is a physically separate device. For example, the notice unit 11, as an audio player or tactile device, can be built into the bioelectrical signal acquisition device 20, e.g., together with one or more reference electrodes 24 or the processing unit 26. In some embodiments, the bioelectrical signal acquisition device 20, the computational unit 31, and the notice unit 11 are a single physically integrated device. For example, the computational unit 31 can be microprocessor integrated into the bioelectrical signal acquisition device 20, e.g., combined with the processing unit 26, and the notice unit 11, as an audio player or tactile device, can be integrated into a headband 21 close to or within the reference electrode 24.

The bioelectrical signal acquisition device 20, the computational unit 31, and the notice unit 11 can communicate with or without wire. For example, the bioelectrical signal acquisition device 20 can transmit signals to the computational unit 31 through wire or wirelessly, e.g., with WIFI or BLUETOOTH. As another example, the computational unit 31 can transmit instructions to the notice unit 11 through wire or wirelessly, e.g., with WIFI or BLUETOOTH.

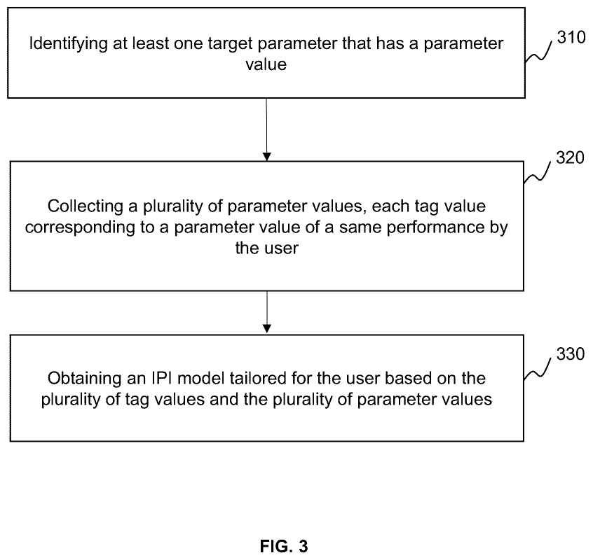

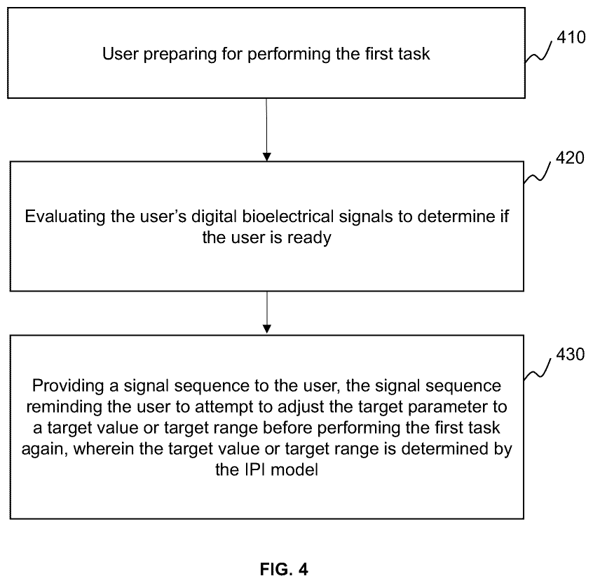

FIG. 2 is a flowchart illustrating an exemplary process for individualized performance improvement (IPI), focusing on signal recording and analysis, according to some embodiments of the present disclosure. In some embodiments, the process illustrated by FIG. 2 can be performed with the aid of the interactive system 50 described above. In some embodiments, the process illustrated by FIG. 2 can be performed in conjunction with the processes illustrated by other Figures (e.g., FIGS. 3 and 4) of the present disclosure.

As shown in step 210 of FIG. 2, a bioelectrical signal acquisition device (e.g., the bioelectrical signal acquisition device 20 described above) may be used to record a batch of digital bioelectrical signals from a user's head. In some embodiments, the recording may occur before and/or during the performance of a first task.

The digital bioelectrical signals recorded by the bioelectrical signal acquisition device 20 may include various types of signals such as but not limited to electroencephalogram (EEG), electromyogram (EMG), and/or electrooculography (EOG) signals. Accordingly, the existence, quantification, and/or patterns of various types of signals can be identified, extracted, and/or calculated from the digital bioelectrical signals recorded. For example, certain brain wave with particular frequency ranges can be extracted from the signals, and the waves may include but are not limited to alpha waves, beta waves, delta waves, theta waves, and gamma waves, and any combination and mixtures thereof.

In some embodiments, this recording occurs before and/or during the performance of a first task by the user. As used here, the first task may refer to any task or activity in which one or more specific mental states may provide an advantage. In some embodiments, the first task may include a task in a sport activity, in a mentally intensive task, or in a creative endeavor. In some embodiments, the first task may include any task to be performed by a person having a mental condition. In some specific cases, the first task can refer to a psychotic episode (e.g., panic attack or violent outburst) that occurs as a result of mental condition.

In some embodiments, the signals that can be used for data extraction and analysis may only include signals recorded before the performance of the first task; this would especially be true for short-duration tasks such as a single sport maneuvers (e.g., golf shot, basketball shot, baseball pitch, etc.). In some embodiments, the signals that can be used for data extraction and analysis may only include signals recorded before and during the performance of the first task; this would especially be true for long-duration tasks such as mentally intensive tasks and creative endeavors. In some embodiments, the long-duration tasks can be segmented into a series of first tasks or sequentially numbered “first task, second task, third task, etc.,” In such cases, it would be possible that the signals that can be used for data extraction and analysis may only include signals recorded before the performance of each task. Such recording can overlap with the task before the task to be performed.

In sport, for example, the first task may include one or more golf strokes, such as a drive (e.g., tee off), an approach, a lay-up, a chip, a punch, or a putt, or any combinations thereof. In certain embodiments, the first task may include a putt. As another example, the first task may include a basket shot. As yet another example, the first task may include a baseball pitch, a baseball swing, or a baseball at-bat. As yet another example, the first task may include a penalty kick in a soccer game. As yet another example, the first task may include a scoring drive in an American football game.

In mentally intensive task/activity, for example, the first task may include taking a standardized test, such as the SAT, GRE, or a professional certification exam, where maintaining high levels of concentration and cognitive function is crucial. It may also include solving complex mathematical problems, engaging in strategic planning sessions, conducting detailed financial analyses, or performing high-stakes negotiations where decision-making and critical thinking are paramount. Additionally, mentally intensive tasks could encompass activities such as coding or debugging software, composing legal documents, or conducting scientific research, where sustained mental effort and precision are required. In creative endeavors, the first task may involve writing a novel, composing music, painting, or designing an innovative product, where mental clarity and inspiration play a significant role in achieving success.

In creative endeavors, for example, the first task may involve writing a chapter of a novel, where the writer needs to maintain a flow of ideas and articulate them effectively. It could also include composing a piece of music, where the musician must blend technical skill with artistic expression to create harmonious melodies. Another example is painting, where the artist requires a steady hand and a clear vision to bring their concept to life on canvas. Additionally, the first task might involve designing a new product or an architectural blueprint, requiring the integration of creativity and technical knowledge to innovate effectively. In these scenarios, the mental state of the individual is crucial, as it influences their ability to generate original ideas, stay focused, and overcome creative blocks, ultimately enhancing their overall performance in the creative process.

The current disclosure also relates to improving the conditions of mentally challenged individuals by providing warnings and reminders so that they can take self-help measures or caregivers can timely intervene. In such cases, the first task can be considered an episode of psychological abnormality (e.g., panic attack). The goal here is to prevent the “first task” being performed, instead of performing the task.

As indicated, the recording of the digital bioelectrical signals by the bioelectrical signal acquisition device 20 may take place before and/or during the performance of a first task. In such a manner, the relevance of the digital bioelectrical signals to the user's activity can be ensured.

In some embodiments, the recording may take a period right before and/or during the task is performed. For example, the recording may start not long (e.g., about n seconds) before the start of performing the first task, e.g., n is 300, 240, 180, 120, 90, 60, 30, 15, 10, or 5, or any range defined by any two numbers thereof. In certain embodiments, the recording can be terminated right before the start of performing the first task. Alternatively, in certain embodiments, the recording can be terminated right after the performance of the first task is completed. Alternatively, in certain embodiments, the recording can be terminated right after multiple performances of the first task are completed. In certain embodiments, the start and/or termination of recording may be controlled by the user, e.g., through an interface shown on a smart device. In certain embodiments, the start and/or termination of recording may be controlled by an assistant or a third-part observer, e.g., through an interface shown on a smart device. It should also be noted that “right before” or “right after” includes “simultaneously with” and before or after by an extremely short amount of time (e.g., 1-5 seconds).

Starting the recording not long before the first task is performed may be particularly suitable for tasks that is performed swiftly (e.g., a golf stroke such as putting, a basketball shot, a soccer kick, or a drive in American football).

In some embodiments, the recording may take a long period of time, especially when the first task (e.g., mentally intensive tasks or creative endeavors) itself takes a longer time (more than 5, 10, 15, 20, 30, 60, 90, or 120 minutes) to be performed. In certain embodiments, the recording may be started right before or simultaneously with the start of performing the first task. In certain embodiments, the recording may be terminated right after the performance of the first task is completed.

As shown by step 220 of FIG. 2, a computational unit (e.g., the computational unit 31 described above) and/or other entities may be used to identify a tag associated with the batch of digital bioelectrical signals recorded in step 210. The tag can be considered a success level of the task performed and the tag has a tag value that indicates that success level.

In some embodiments, the tag value can be a set of dichotomous values. For example, in certain embodiments, the tag value is in or out (e.g., for a basketball shot, a soccer panel kick, a gold putting stroke); in certain embodiments, the tag value is hit or miss (e.g., for a shooting sport); in certain embodiments, the tag value may is in range or not in range (e.g., for a golf stroke); in certain embodiments, the tag value may be desired performance or undesired performance. In such cases, the dichotomous values may be processed in their natural language form, or may be converted to a binary form (e.g., 1 and 0) before being further processed digitally. In certain embodiments of the present disclosure, “hit” and “miss” are generally used to represent the values in the dichotomous-value approach.

Similar to the dichotomous-value approach, the tag value may be three or more separate specific values, which can be presented and/or processed in natural language form or converted digital form. For example, one set of tag values may include fail, fair, and excellent; another set of tag values may include unacceptable, acceptable, fair, good, excellent; yet another set of tag values may be 10, 9, 8, 7, 6, 5, 4, 3, 2, 1, 0 (e.g., for archery competition).

In some embodiments, the tag value may be represented numerically in a continuous range. Take golf drive as an example, the tag value may be a distance of the stroke/drive, e.g., in meters, yards, or feet. As another example, the tag value may be a time of a 100-meter dash, e.g., in seconds.

The tag and tag value may be determined by an entity, such as but not limited to the user himself/herself, a third party assistant/helper/evaluator (e.g., coach or referee), an agency (e.g., sport organization), and any other observers who can provide evaluation of the tag value. The tag value may be recorded by the same entity that determines the tag value or by another entity.

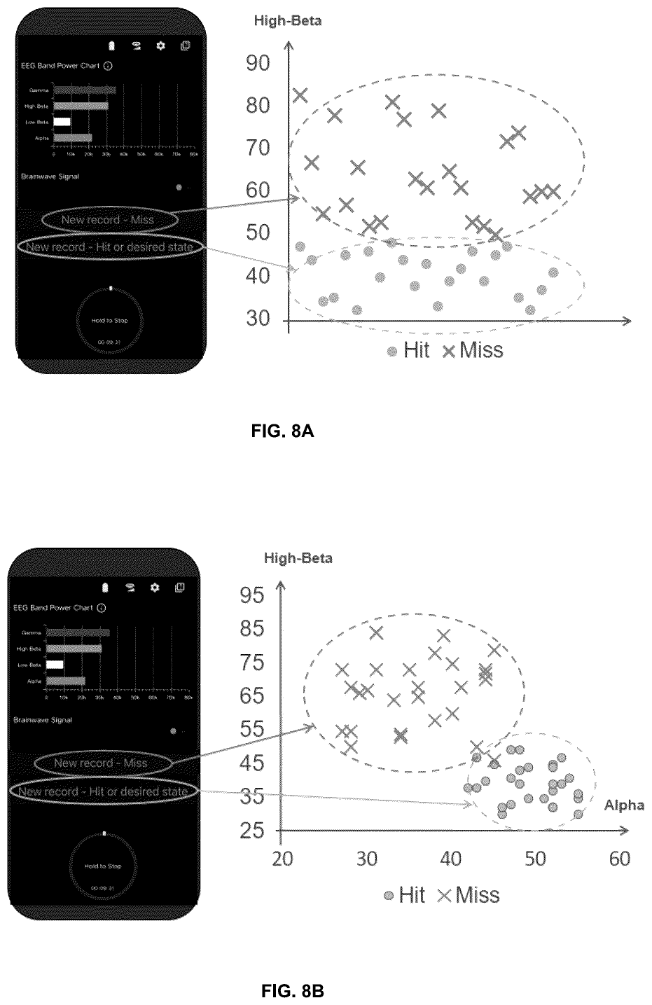

The tag value can be provided and recorded with various approaches. In essence, such approach can be considered to be using a “tagging signal”. For example, the tag value can be provided verbally (e.g., by the entity) and recorded by digital inputs—the words are the tagging signals. Referring to FIGS. 8A and 8B, whose left panels show a smart phone interface of an application designed for bioelectrical signal recording and analysis, the user/assistant can input the tag value (e.g., “hit or desire state” or “miss”). The user/assistant can press the button/link, thereby providing a tagging signal, when a performance is completed to record the result. In some cases, the recording is continuous after it is started, and the user/assistant can terminate the recording by pressing the “hold to stop” button as shown in the left panels of FIGS. 8A and 8B.

One of many approaches that can be used to provide the tag value is to use one or more ocular events, such as but not limited to visual recording of eye maneuverers (e.g., blinking or looking to a certain direction) or ocular event-related potentials (o-ERPs) that can be recorded by the bioelectrical signal acquisition device. In some embodiments, a visual recording device can capture the eye maneuverers. In some embodiments, the o-ERPs are part of the bioelectrical signals and the computational unit can extract and detect the o-ERPs.

In some embodiments, the o-ERPs result from voluntary actions such as but limited to eye blinking, eye movement (including eye rolling), or eyelid squeezing, or any combination thereof, by the user of the bioelectrical signal acquisition device. For example, after the first task is performed, the user may use eye movements, eye blinks, or eyelid squeezes, e.g., according to preset patterns, to generate o-ERPs, so that the bioelectrical signal acquisition device and computational unit can determine the tag value based on the pattern of existence and/or pattern of the o-ERPs. The benefit of the o-ERP approach is that it can be non-intrusive and discreet, with minimum interruption; in some cases it is also advantageous because it does not require additional devices to carry out the whole process.

As shown by step 230 of FIG. 2, the steps of 210 and 220 can be repeated multiple times so that multiple batches of bioelectrical signals can be collected, each with a corresponding tag value. Referring to the right panels of FIGS. 8A and 8B, the computational unit can process the multiple batches of recorded signals, analyzing them to identify patterns and correlations between the bioelectrical activity and tag values (task success levels). Such repetitions would enhance the accuracy and reliability of the analysis and resulting performance improvement recommendations.

FIG. 3 is a flowchart illustrating an exemplary process for individualized performance improvement, focusing on identifying a target parameter and obtaining an IPI model. In some embodiments, the process illustrated by FIG. 3 can be performed with the aid of the interactive system 50 described above. In some embodiments, the process illustrated by FIG. 3 can be performed in conjunction with the processes illustrated by other Figures (e.g., FIGS. 2 and 4) of the present disclosure.

As shown in step 310 of FIG. 3, the interactive system may identify at least one target parameter, which is highly relevant to the user's performance. In some embodiments, the target parameter is a specific aspect of the user's bioelectrical activity or performance metrics that can influence the overall success of performing a task (e.g., the first task).

Each of the at least one target parameter has a parameter value, which represents a quantitative measurement of the specific aspect of the user's bioelectrical activity or performance metrics. Examples of target parameters include the specific brainwaves (e.g., alpha, beta, delta, theta, and/or gamma waves), reaction time, or physiological responses such as heart rate variability. Identifying the appropriate target parameters may be crucial as it may ensure that the analysis and intervention focuses on impactful elements of the user's performance.

The target parameter can be identified through various approaches. In some embodiments, the interactive system may select the at least one target parameter from a plurality of candidate parameters. For example, the target parameter may be identified through certain sub-steps indicated as follows. It should be noted that at least some of the sub-steps are optional.

In some embodiments, as an initial matter, a comprehensive list of candidate parameters that could potentially influence performance can be identified. These candidate parameters may include various types of bioelectrical signals and physiological metrics, such as but not limited to brainwaves (e.g., alpha, beta, delta, theta, gamma waves), heart rate and heart rate variability, muscle activity (e.g., electromyogram signals), eye movements and blinks (e.g., electrooculography signals), skin conductance and temperature, and respiratory rate. In certain embodiments, the candidate parameters may include brain waves such as but not limited to alpha waves, beta waves (high beta and/or low beta), delta waves, theta waves, gamma waves, other any combinations thereof. In certain embodiments, the candidate parameters may include any signals/frequencies/patterns (e.g., o-ERPs) that can be extracted from bioelectrical signals that may be recorded from a user's head.

In some embodiments, baseline data for each candidate parameter can be collected by monitoring the user's bioelectrical and/or physiological activities during a period of rest and non-performance. This baseline data may serve as a reference point to understand the user's normal state, aiding in identifying deviations and patterns specific to task performance.

In some embodiments, as in conjunction with the process illustrated in FIG. 2, the user may perform a task (e.g., the first task) multiple times so that a plurality of tag values may be collected, each tag value being associated with a batch of digital bioelectrical signals and a performance of the first task. In the meantime, during such performances, the values for all the candidate parameters may be collected. Such performances and data gathering may help in building a broad dataset that includes variations in bioelectrical and physiological responses during task performance.

In some embodiments, the interactive system may use statistical analysis and data processing techniques to analyze the correlation between each candidate parameter and the task performance outcomes. Techniques such as but not limited to Pearson correlation, Spearman rank correlation, or regression analysis can help identify which parameters have a significant impact on performance success.

In some embodiments, based on the correlation analysis, the interactive system may identify the parameters that show a strong and consistent relationship with performance outcomes. In certain embodiments, parameters with higher correlation coefficients or significant p-values may be considered more influential and may be shortlisted as potential target parameters. In certain embodiments, parameters with higher correlation coefficients or significant p-values may be selected directly as the target parameters.

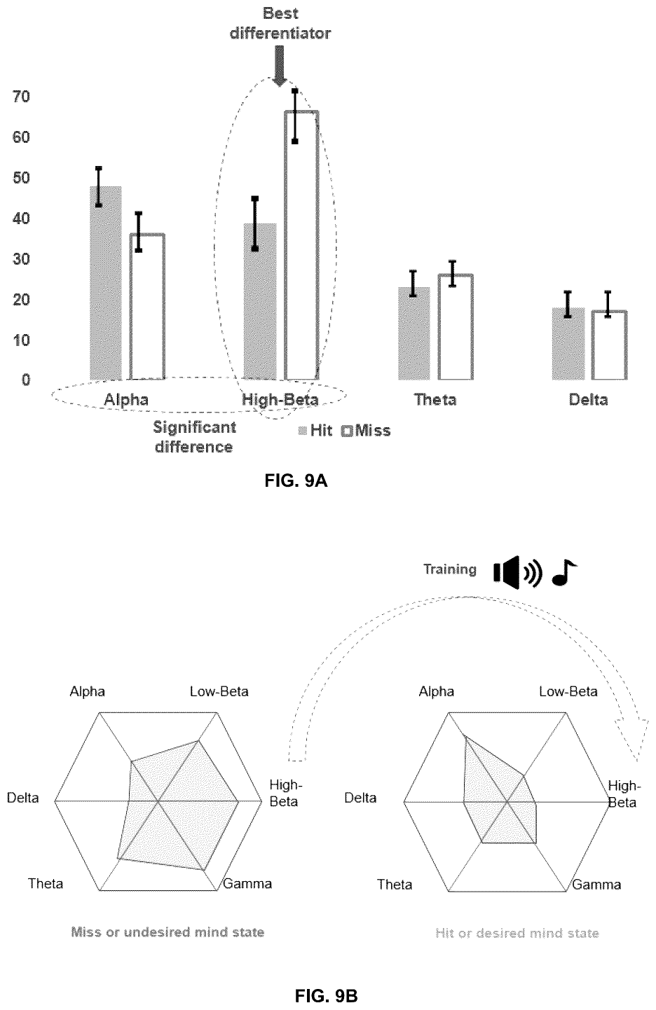

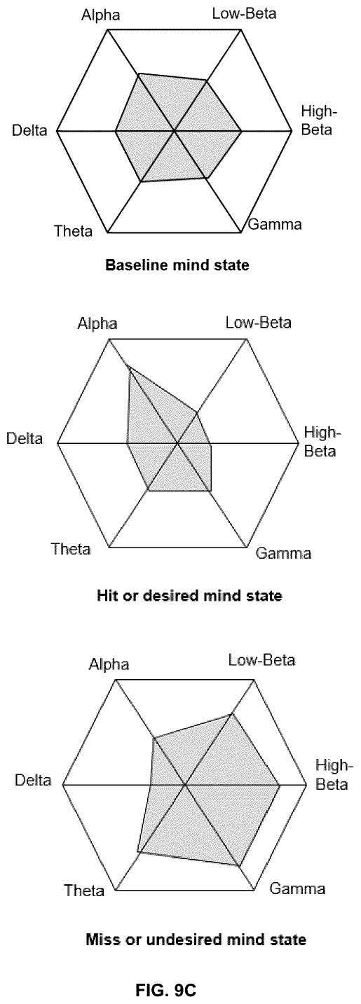

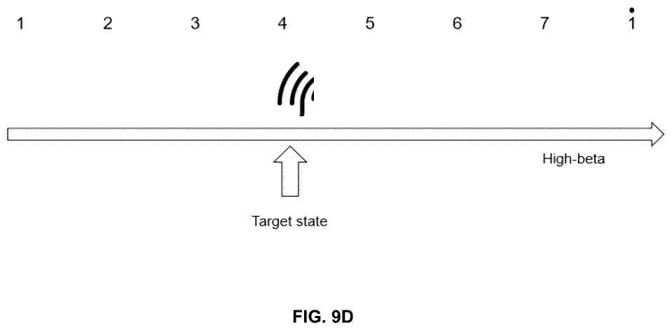

FIG. 9A shows an example of using statistical method to identify useful differentiating factors (target parameters) for hit or miss performances. As illustrated here, in some embodiments, various candidate parameters are extracted from the bioelectrical signals recorded from the user's head, that their correlations with hit or miss performances are analyzed, e.g., by comparing the parameter values of the group of “hit” performances with those of the “miss” performances. As shown in FIG. 9A, while other brain waves fail to provide a distinction between the two groups, high-beta brain wave is identified as the best differentiator, and in some cases, can be considered the target parameter.

In some embodiments, the interactive system may perform cross-validation by dividing the collected data into training and testing sets; furthermore, the interactive system may use the training set to develop preliminary models incorporating the identified significant parameters, and then validate these models using the testing set. This helps ensure that the identified parameters are robust predictors of performance across different data samples.

In some embodiments, the interactive system may prioritize the shortlisted parameters based on their correlation strength, ease of measurement, and/or practical relevance to the task. In certain embodiments, the interactive system may select the final one or more target parameters that provide the most accurate and actionable insights for performance improvement. In certain embodiments, the candidate parameters are ranked according to their correlation strength, ease of measurement, and/or practical relevance, and one or more target parameters are selected according to the rank.

In some embodiments, only one target parameter is selected. In some embodiments, multiple target parameters are selected, and they are used in a collective manner, e.g., with varied corresponding weights or the same weight, or e.g., using a function that incorporates all the target parameters, to construct and/or perfect the IPI model.

FIG. 9B provides an example for identifying multiple parameters that might be responsible for hit or miss, as well as possible transition from an undesired mind state (miss) to a desired mind state (hit) with audio neurofeedback interventions (a signal sequence). As show in FIG. 9B, various brainwave signals (alpha, low-beta, high-beta, gamma, theta, and delta) can be extracted from the bioelectrical signals and analyzed. In some embodiments, the parameter values in the “miss” group can be compared to those in the “hit” group; several differentiating factors (target parameters) can be identified. In some cases, all these brainwaves may be identified as target parameters because certain levels of distinction can be found in the “hit” group as compared to the “miss” group.

As shown in step 320 of FIG. 3, in conjunction with the process illustrated in FIG. 2, the interactive system may collect a plurality of parameter values, where each tag value corresponds to a parameter value for the same performance by the user. In some embodiments, this involves continuously recording bioelectrical signals across multiple instances of task performance. In some embodiments, this involves segmented recording of data for multiple instances of task performance. The process may involve the bioelectrical signal acquisition devices, as described in FIGS. 1-2, which captures detailed and precise data necessary for accurate analysis.

When there is only one target parameter, it has a parameter value that corresponds to the tag value of the same performance. When there are multiple target parameters, each of the target parameters has a parameter value that corresponds to the tag value of the same performance.

Gathering parameter values and tag values before and/or during the performance of tasks provides context-specific data for the user himself/herself. This helps in understanding how the specific user's bioelectrical and physiological responses vary in different performance scenarios, thereby offering insights into the specific conditions under which certain patterns emerge. In essence, the collection of parameter values alongside corresponding tag values (representing performance outcomes) allows for the direct correlation of bioelectrical activity with performance success. This correlation is essential for identifying which aspect of the bioelectrical signals are predictive of high performance and which might indicate areas for improvement.

As shown in step 330 of FIG. 3, the collected data from steps 310 and 320, as well the data from the process illustrated in FIG. 2, may be used to obtain an Individualized Performance Improvement (IPI) model tailored specifically for the user. Such an individualized approach could ensure precise and target intervention. The IPI model integrates the plurality of tag values and parameter values to establish patterns and correlations that can predict or influence performance outcomes. This model can be developed using advanced computational techniques such as machine learning algorithms or statistical analysis methods, which process the extensive dataset to identify key predictors of performance success. The resulting IPI model provides personalized insights and recommendations for performance enhancement based on the user's unique bioelectrical and performance data.

The IPI model can be established through various approaches. In some embodiments, creating the IPI model involves leveraging the collected bioelectrical and performance data to train a preliminary model. For example, the IPI model may be created through certain sub-steps indicated as follows.

In some embodiments, before training the preliminary model to obtain the IPI model, the collected data may be preprocessed to ensure it is clean and ready for analysis. In certain embodiments, this may involve: (a) data cleaning-removing any noise or artifacts from the data (e.g., the bioelectrical signals); (b) normalization-standardizing the data to ensure consistent scales across different parameters; and/or (c) segmentation-dividing the continuous data (if any) into meaningful segments corresponding to each task performance.

In some embodiments, the interactive system may extract relevant features that are indicative of performance success are extracted from the preprocessed data. This may involve: statistical features such as but limited to mean, variance, skewness, and kurtosis of the bioelectrical signals; frequency features such as but not limited to power spectral density, dominant frequencies, and frequency bands; and temporal features such as but not limited to signal peaks, troughs, and latency periods. Take EEG signals as an example, in some cases, it would be necessary to perform Fast Fourier Transform (FFT) to make the data ready for further analysis.

In some embodiments, the interactive system may split the dataset into training and testing sets to facilitate model development and evaluation. The training set may be used to train a preliminary model to arrive at the trained IPI model; the testing set may be used to validate and test the performance of the trained IPI model. In some embodiments, when there is no splitting, the training dataset is the entire dataset. In some embodiments, when there is splitting, the training dataset is part of the entire dataset.

In some embodiments, various machine learning algorithms (with associated preliminary models) are evaluated to determine the best fit for the IPI model. Commonly used algorithms include but are not limited to: linear regression (e.g., can be used for but not limited to continuous tag values such as but not limited to distance, e.g., for a golf drive); logistic regression (e.g., can be used for but not limited to dichotomous tag values such as but not limited to hit or miss, in or out); decision trees and random forests (e.g., can be used for but not limited to both continuous and categorical tag values); support vector machines (SVM) (e.g., can be used for but not limited to classification tasks with multiple tag values); neural networks (e.g., can be used for but not limited to complex patterns and large datasets).

In some embodiments, with the selected algorithm, an associated preliminary model is then trained using the training dataset. In certain embodiments, this training process may involve: (a) parameter tuning (e.g., adjusting hyperparameters to optimize model performance); and (b) cross-validation (e.g., using techniques such as k-fold cross-validation to ensure the model generalizes well to unseen data.

In some embodiments, the trained IPI model is validated using the testing set to evaluate its accuracy and reliability. In certain embodiments, such validation may involve model performance metrics such as but not limited to accuracy, precision, recall, F1-score, and mean squared error; and/or model confusion matrix such as but not limited to positives, false positives, true negatives, and false negatives.

In some embodiments, the interactive system may refine the trained IPI model to improve its accuracy and robustness. In certain embodiments, such refinement may be based on the validation results. In some embodiments, the refinement process may involve feature engineering (e.g., adding or modifying features to enhance model predictions); algorithm adjustment (e.g., trying different algorithms or ensemble methods); re-training (e.g., re-training the model with updated data or parameters).

In some embodiments, after the IPI model is deployed for practical use (e.g., the process illustrated in FIG. 4), the interactive system may continuously monitor the IPI model and conduct periodic updates to maintain the model's effectiveness. In certain embodiments, such maintenance may be based on user feedback (e.g., by incorporating feedback from the user to refine the model). In certain embodiments, the updates may be conducted by periodically retraining the model with new data to adapt to changes in the user's performance patterns.

The IPI models herein described can be used to determine optimum parameter values (i.e., target value) or range of parameter values (i.e., target range) for the target parameter(s), and such models can be used for various tasks in which specific mental and/or physical states can provide advantage for the performance of such tasks.

In some embodiments, the IPI model may be used in sports. E.g., a golfer's IPI model may use a neural network trained with alpha brainwave values; the model may predict the likelihood of a successful putt and provides recommendations on mental states to optimize performance; in some cases, in addition to the mental state, muscle activity and/or heart rate variability may also be considered target parameters, and the optimization recommendations may include values (i.e., target values) or ranges of parameter values (i.e., target ranges) for all these target parameters.

Another example of the user of IPI models may be performance for mentally intensive tasks (e.g., academic performances such as exams). The IPI model for a student may employ a support vector machine (SVM) trained on gamma wave signals. The model may predict the student's concentration level and suggests techniques to maintain focus during exams.

FIG. 4 is a flowchart illustrating an exemplary process for individualized performance improvement, focusing on user preparation and real-time feedback. In some embodiments, the process illustrated by FIG. 4 can be performed with the aid of the interactive system 50 described above. In some embodiments, the process illustrated by FIG. 4 can be performed in conjunction with the processes illustrated by other Figures (e.g., FIGS. 2 and 3) of the present disclosure.

In some embodiments, the process of FIG. 4 can be performed as a direct continuation of the processes of FIGS. 2-3. In essence, right after (e.g., in the same day, the same training session, etc.) the collection of data that establishes the IPI model, the user tries the first task again, using the results of the IPI model for steps 420 and 430. The benefit of this approach is that the IPI model, together with the target value and/or target range determined by the IPI model, may be more precise due to the closeness of the model-building process and the target performance. In some embodiments, the process of FIG. 4 can be performed separately (e.g., different day, different training session, etc.) from the processes of FIGS. 2-3. In essence, after the collection of data that establishes the IPI model, the user tries the first task again, using the results of the IPI model for steps 420 and 430. The benefit of this approach is that it provides more flexibility as to how the processes can be arranged.

As shown in step 410 of FIG. 4, and in conjunction with FIGS. 2-3, the user may prepare to perform a first task. This preparation phase may be crucial as it sets the stage for optimal performance. In some embodiments, this preparation phase can be crucial as it sets the stage for optimal performance. In certain embodiments, the preparation may involve mental readiness specific to the nature of the task; additionally, the preparation may also involve physical readiness.

As shown in step 420 of FIG. 4, the interactive system may evaluate the user's digital bioelectrical signals to determine if the user is ready to perform the first task, e.g., performing the first task in an optimal mental and/or physical state.

In some embodiments, the bioelectrical signal acquisition device may be used to record signals such as EEG, EMG, and EOG from the user's head, as described above. Such bioelectrical signals may be used for the analysis of step 420. In some embodiments, readiness is assessed by extracting current parameter values of the target parameters from the recorded bioelectrical signals and comparing the current parameter values with predefined criteria (target values or target ranges) established by the IPI model. In some embodiments, the IPI model is trained to recognize optimal states for various tasks, wherein the optimal states are represented by target values or target ranges of the target parameters.

In some embodiments, the interactive system may analyze the bioelectrical signals, e.g., by determining a current parameter value of the at least one target parameter within the bioelectrical signals; subsequently, the interactive system may determine whether the current parameter value correlates with a readiness state. The target parameter may include specific brain wave activities (alpha, beta, delta, theta, and gamma waves). In some cases, the readiness state may also be reflected by parameters other than mental states, such as but not limited to muscle activity and eye movements. In some embodiments, only one target parameter is involved. In some embodiments, multiple target parameters are involved.

FIG. 9C shows examples of EEG parameters using hexagon presentations, wherein the “baseline mind state”, the “desired mind state” (“hit”), and the “undesired mind state” (“miss”) have been matched by collecting multiple rounds of bioelectrical signals and by the IPI model with target values or target ranges of alpha, low-beta, high-beta, gamma, theta, and delta brainwaves. Based on the target values or the target ranges, a comprehensive “target pattern”, as shown in the hexagon presentation of the “desired mind state”, can be established. When the current bioelectrical signals have been recorded and analyzed, the current values of the target parameters can be similarly represented by a hexagon presentation, creating a “current pattern”; thereafter, a comparison of the “current pattern” with the “target pattern” can be used to determine whether the user is in the “desired mind state”. If not, instant feedback (by delivering a signal sequence) can be provided to remind the user to attempt to transition to the “desired mind state”.

The process of bioelectrical signal analysis may be simplified or may be complex. In some embodiments, such a process may include the following steps.

In some embodiments, the interactive system may apply digital filters to remove artifacts and noise from the raw signals. Such an approach may include band-pass filters to isolate relevant frequency ranges for EEG, EMG, and EOG signals. In certain embodiments, specific techniques such as but not limited to independent component analysis (ICA) may be used to separate and clean signals. In some embodiments, the interactive system may segment the bioelectrical signals into relevant time windows for analysis, e.g., segmenting the signals into 1-second intervals to examine immediate brain activity.

In some embodiments, only specific segments are sued

In some embodiments, the interactive system may extract key features from the processed signals, such as amplitude, frequency, and phase of the signals. In certain embodiments, the interactive system may identify specific patterns in the signals, e.g., patterns that represent brain waves (e.g., alpha, beta, delta, theta, gamma waves). Specifically, in some embodiments, the interactive system may analyze the extracted features to identify significant waveforms, e.g., for EEG, this includes recognizing alpha waves (8-12 Hz), beta waves (13-30 Hz), theta waves (4-7 Hz), delta waves (0.5-4 Hz), and gamma waves (>30 Hz).

In some embodiments, the interactive system may compare the identified waveforms and patterns against predefined templates or models that represent optimal readiness states. For example, high alpha wave activity might indicate relaxation and readiness. In certain embodiments, it would be necessary for the interactive system to identify and exclude artifacts (e.g., eye blinks, muscle movements) that may distort the analysis. In certain embodiments, the interactive system may use automated algorithms to detect and remove these artifacts.

In some embodiments, the interactive system may compare the identified patterns with the parameter value that correlates with optimal states required for the first task; such parameter value of the target parameter is provided by the IPI model. Specifically, the interactive system may evaluate if the identified patterns based on the extracted features matches the parameter value, which in some cases is represented by thresholds for readiness determined by the IPI model. For instance, the interactive system may check if alpha wave amplitude exceeds a certain value that indicates a calm state.

In some embodiments, when multiple target parameters are involved, statistical methods or machine learning models may be used to assess readiness based on multiple features simultaneously. FIG. 9C provides examples for multiple target parameter matching and possible transition between different mind states.

In certain embodiments, it would be necessary to generate a readiness score or index based on the comparative analysis; this score quantifies how ready the user is to perform the first task. In certain embodiments, the interactive system may rank the readiness score within a defined range (e.g., 0-100) to provide a clear indication of readiness level.

As shown in step 430 of FIG. 4, as a result of the evaluation of the bioelectrical signals, the interactive system may provide a signal sequence to the user. In some embodiments, this signal sequence may act as a reminder or prompt for the user to adjust their target parameters to a target range before performing the first task again. For example, as shown in FIG. 9B, audio signals can be used to urge the user to attempt to adjust his/her target parameters to target values or target ranges (from “miss” to “hit”), essentially transitioning from an undesired mind state to a desired mind state.

In some cases, the step 420 results in a determination that the user is not optimally ready to perform the first task. Such a determination may require reminding to the user to make certain adjustment. In some embodiments, the step 420 results in a determination that the user is ready; in certain cases, no action is taken the and the user may proceed with the performance; in certain cases, the interactive system may let the user know (e.g., with a signal sequence) that he/she is ready and can proceed with the performance.

The signal sequence can be delivered through various means, such as but not limited to auditory signals (e.g., tones indicating relaxation or stress levels, instructions to the user to try to be calm, specific guide to the user to conduct certain activities to be calm, etc.), visual displays (e.g., brain wave activity graphs), or haptic feedback (e.g., vibrations indicating the need to adjust focus), or a combination thereof. In some embodiments, the signal sequence is used to remind or prompt the user to modify his/her mental and physiological state to align with the target range specified by the IPI model. In some embodiments, this target range is determined based on the correlation between bioelectrical patterns and successful task performance. In essence, based on the analysis from the IPI model, the interactive system may provide personalized recommendations to help the user achieve the target mental state. In certain embodiments, these recommendations may include specific actions, such as deep breathing exercises, muscle relaxation techniques, or visualization practices.

In some embodiments, the interactive system may offer actionable insights derived from the user's bioelectrical signal patterns. For example, if the user shows high beta wave activity indicating stress, the IPI model might suggest mindfulness exercises to reduce stress levels. Such actionable insights may prompt the user to try certain actions such as but not limited to meditation, focused breathing or body scanning, visualization of successful performance, etc.

In some embodiments, a pre-designed tiered template can be used to notify the user about his/her mental state. For example, in some cases, a certain brainwave (e.g., high beta) is identified as the target parameter, and each power level of the brainwave is matched with a certain audio signal (e.g., a specific tone, or a specific word, etc.). This would provide more precise and specific information to the user.

Referring to FIG. 9D, taking a specific tone as an example, lower power of the high-beta brainwave is matched with a lower tone; higher power is matched with a higher tone, with several levels (e.g., 7) of different tones. When the user is preparing to perform the task, his/her brain signals are recorded and analyzed; the interactive system may provide an audio signal with a specific tone to the user, so that he/she knows what mental state he/she is in. The user can be informed beforehand which tone (e.g., tone “4”) indicates his/her optimal mind state, so that when he/she hears the specific tone, he/she knows: (1) whether he/she is in the optimal state, and (2) which direction he/she should try to adjust his/her mind to reach the optimal state if he/she is not in the optimal state yet. In some embodiments, the tiered template system can be combined with a separate notification signal, which would notify the user as to whether the optimal state has been reached. For example, the “tone” system can be combined with a “double-ding” signal-so that the user may hear a specific tone to know his/her mind state, but only when a double-ding is received would he/she understand that he/she has arrived at the optimal state.

The importance of providing a signal sequence before task performance lies in its ability to help users enter an optimal state, enhancing their chances of success. By aligning their bioelectrical and physiological states with the target parameters identified by the IPI model, users can perform tasks with greater efficiency and effectiveness.

This process of preparing, evaluating, and adjusting ensures that the user is not only ready to perform the task but is also in the best possible state to achieve the desired outcomes. The iterative nature of the process allows for continuous improvement and fine-tuning, leading to sustained performance enhancement over time.

FIGS. 2-4 demonstrate an individualized approach to improve performance, which is advantageous, especially when compared to conventional generic methods, because there are significant variations in how people's performance can be enhanced. In many cases, it should be understood that a person's optimized performance for a given task can be achieved only when the mental activation is at a specific level that is neither complete relaxation nor fully engaged. Thus, performance improvement would require a subtle and precise adjustment of the mental states, which can only be achieved at a personal level.

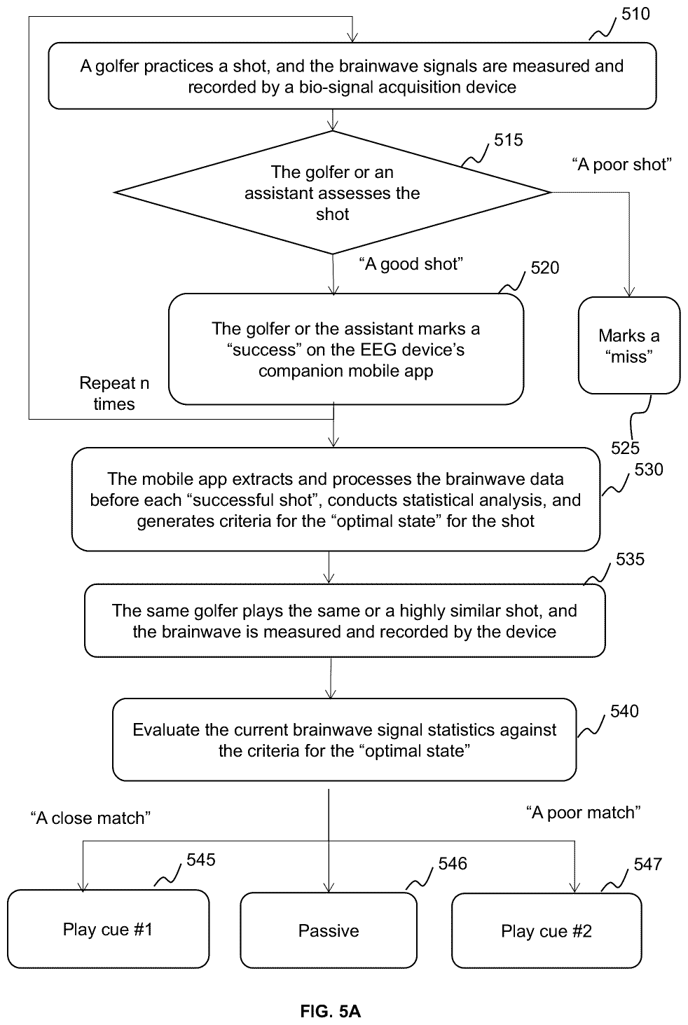

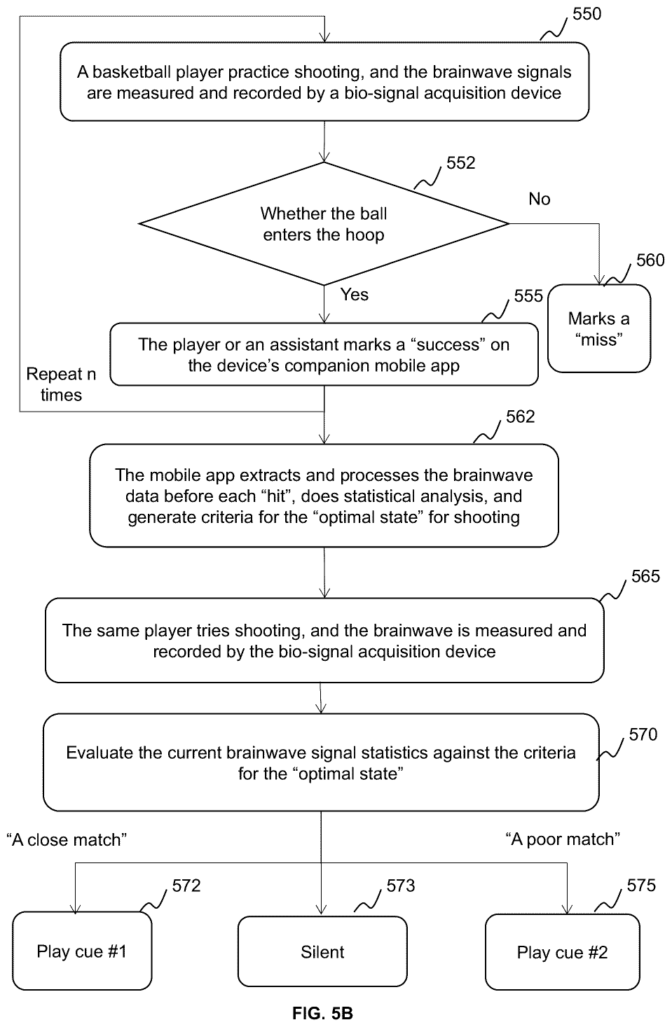

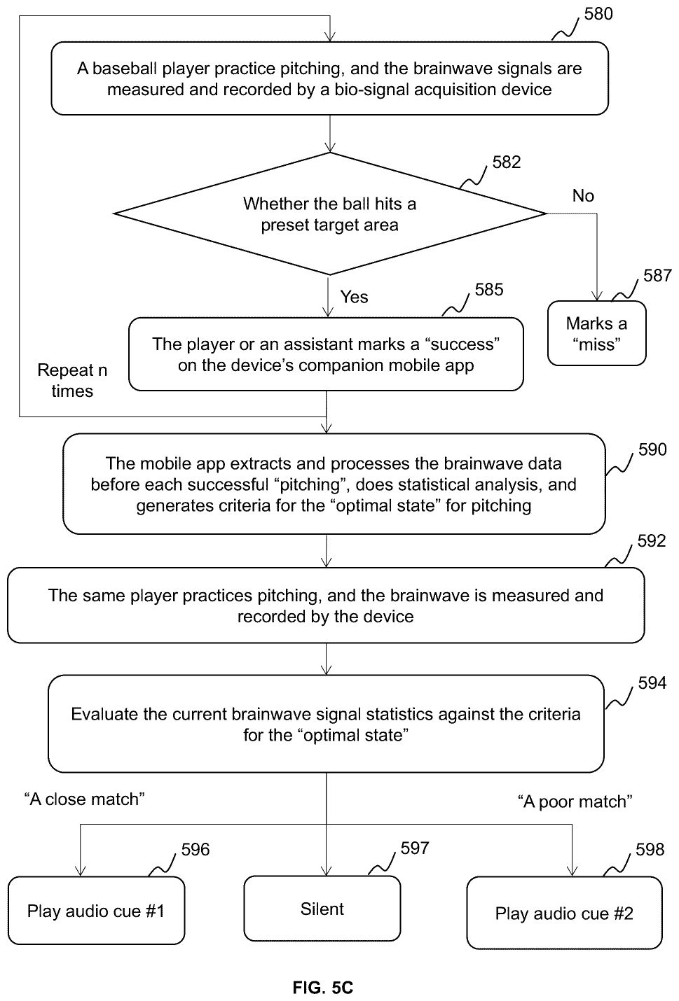

FIG. 5A is a flowchart illustrating an exemplary process for individualized performance improvement in a golf shot according to some embodiments of the present disclosure. This process provides a specific example for the processes illustrated in FIGS. 2-4.

As shown in step 510 of FIG. 5A, a golfer (as the “user” described in FIGS. 2-4) may engage in practicing a shot (as the “first task” described in FIG. 2-4), with brainwave signals being measured and recorded by a bio-signal acquisition device. The device is typically worn on the golfer's head. In some embodiments, the device is the bioelectrical signal acquisition device 20 shown in FIG. 1.

As shown in step 515, after the shot, the golfer or an assistant evaluates the shot's outcome, which involves determining whether the shot was successful or not. In certain embodiments, if the shot is an attempted final putt, the measurement of success can be in or out. Otherwise, there can be other standard (dichotomous or continuous) for the measurement of success.

As shown in steps 520 and 525, the golfer or the assistant may record the shot as a “success” (or “hit”) or a “miss” on the bioelectrical signal acquisition device's companion mobile application. The process of 510, 515, 520 and 525 may be repeated n time, n being an integer greater than 1.

In certain embodiments, such marking may trigger the application to extract and process brainwave data corresponding to the shot, as shown in 530. In certain embodiments, data extraction and processing are only triggered after the number of performances has reached a threshold.

In some embodiments, the mobile application conducts statistical analysis on the brainwave data preceding each successful shot. In some embodiments, the mobile application conducts statistical analysis on the brainwave data preceding all the shots. Based on the results of either approach, the mobile application generates criteria for an “optimal state” for performing the shot. In some embodiments, the optimal state is represented by one or more parameter values or ranges for one or more target parameters. In some embodiments, the parameter values or ranges may be generated by a IPI model, as described in FIGS. 2-4.

With real-life testing, it is found that high-beta brainwaves are the most relevant parameter for golf shots, as for certain other sport tasks. In addition, the signals in the segment that's about 4 seconds before the performance can be the most relevant. Therefore, in some case, the signals from the 4-second segments before the performance are used for signal extraction, analysis, and determination of the target parameters, which, in the case of golf shots, would most likely include high-beta signals.

As shown in step 535, the same golfer plays the same or a highly similar shot when his/her brainwave signals are measured and recorded by the bioelectrical signal acquisition device. As shown in 540, the acquired signals are evaluated and compared to the criteria established earlier. Specifically, a determination is made as to whether the acquired signals, after extraction and statistical analysis, would be matched with the “optimal state”.

As shown in 545, 546, and 547, if the system determines that it is a “close match”, cue #1 (audio, visual, and/or haptic) is played; if it is a “poor match”, cue #2 (audio, visual, and/or haptic) is played. If a determination cannot be made with a high level of reliability, the system may stay passive. In some embodiments, cue #1 would urge the golfer to proceed with the shot; cue #2 may prompt the golfer to adjust his/her mental state, so that the “optimal state” can be achieved. In certain embodiments, cue #2 made include specific instructions as to how the “optimal state” might be arrived at.

FIG. 5B is a flowchart illustrating an exemplary process for individualized performance improvement in a basketball shooting according to some embodiments of the present disclosure. This process provides a specific example for the processes illustrated in FIGS. 2-4.

As shown in step 550 of FIG. 5B, a basketball player (as the “user” described in FIGS. 2-4) may engage in practicing a shot (as the “first task” described in FIG. 2-4), with brainwave signals being measured and recorded by a bio-signal acquisition device. The device is typically worn on the basketball player's head. In some embodiments, the device is the bioelectrical signal acquisition device 20 shown in FIG. 1.

As shown in steps 552, 555, and 560, the basketball player or the assistant may record the shot as a “success” (or “hit”) or a “miss” on the bioelectrical signal acquisition device's companion mobile application. This is more clear-cut scenario than the golf shot because there is no ambiguity in whether the ball enters the hoop. The process of 550, 552, 555 and 560 may be repeated n time, n being an integer greater than 1.

In certain embodiments, such marking may trigger the application to extract and process brainwave data corresponding to the shot, as shown in 562. In certain embodiments, data extraction and processing are only triggered after the number of performances has reached a threshold.

In some embodiments, the mobile application conducts statistical analysis on the brainwave data preceding each successful shot. In some embodiments, the mobile application conducts statistical analysis on the brainwave data preceding all the shots. Based on the results of either approach, the mobile application generates criteria for an “optimal state” for performing the shot. In some embodiments, the optimal state is represented by one or more parameter values or ranges for one or more target parameters. In some embodiments, the parameter values or ranges may be generated by a IPI model, as described in FIGS. 2-4.

As shown in step 565, the same basketball player tries the shooting again, when his/her brainwave signals are measured and recorded by the bioelectrical signal acquisition device. As shown in 570, the acquired signals are evaluated and compared to the criteria established earlier. Specifically, a determination is made as to whether the acquired signals, after extraction and statistical analysis, would be matched with the “optimal state”.

As shown in 572, 573, and 575, if the system determines that it is a “close match”, cue #1 (audio, visual, and/or haptic) is played; if it is a “poor match”, cue #2 (audio, visual, and/or haptic) is played. If a determination cannot be made with a high level of reliability, the system may stay passive. In some embodiments, cue #1 would urge the basketball player to proceed with the shot; cue #2 may prompt the basketball player to adjust his/her mental state, so that the “optimal state” can be achieved. In certain embodiments, cue #2 made include specific instructions as to how the “optimal state” might be arrived at.

FIG. 5C is a flowchart illustrating an exemplary process for individualized performance improvement in a baseball pitch according to some embodiments of the present disclosure. This process provides a specific example for the processes illustrated in FIGS. 2-4.

As shown in step 580 of FIG. 5C, a baseball pitcher (as the “user” described in FIGS. 2-4) may engage in practicing a pitch (as the “first task” described in FIG. 2-4), with brainwave signals being measured and recorded by a bio-signal acquisition device. The device is typically worn on the baseball pitcher's head. In some embodiments, the device is the bioelectrical signal acquisition device 20 shown in FIG. 1.

As shown in step 582, after the pitch, it would be determined as whether the pitch hits a preset target area. As shown in steps 585 and 587, the baseball pitcher or the assistant may record the shot as a “success” (or “hit”) or a “miss” on the bioelectrical signal acquisition device's companion mobile application. The process of 580, 582, 585 and 587 may be repeated n time, n being an integer greater than 1.

In certain embodiments, such marking may trigger the application to extract and process brainwave data corresponding to the shot, as shown in 590. In certain embodiments, data extraction and processing are only triggered after the number of performances has reached a threshold.

In some embodiments, the mobile application conducts statistical analysis on the brainwave data preceding each successful pitch. In some embodiments, the mobile application conducts statistical analysis on the brainwave data preceding all the pitches. Based on the results of either approach, the mobile application generates criteria for an “optimal state” for performing the pitch. In some embodiments, the optimal state is represented by one or more parameter values or ranges for one or more target parameters. In some embodiments, the parameter values or ranges may be generated by a IPI model, as described in FIGS. 2-4.

As shown in step 535, the same baseball pitcher plays the same or a highly similar pitch when his/her brainwave signals are measured and recorded by the bioelectrical signal acquisition device. As shown in 540, the acquired signals are evaluated and compared to the criteria established earlier. Specifically, a determination is made as to whether the acquired signals, after extraction and statistical analysis, would be matched with the “optimal state”.

As shown in 545, 546, and 547, if the system determines that it is a “close match”, cue #1 (audio, visual, and/or haptic) is played; if it is a “poor match”, cue #2 (audio, visual, and/or haptic) is played. If a determination cannot be made with a high level of reliability, the system may stay passive. In some embodiments, cue #1 would urge the baseball pitcher to proceed with the shot; cue #2 may prompt the baseball pitcher to adjust his/her mental state, so that the “optimal state” can be achieved. In certain embodiments, cue #2 made include specific instructions as to how the “optimal state” might be arrived at.

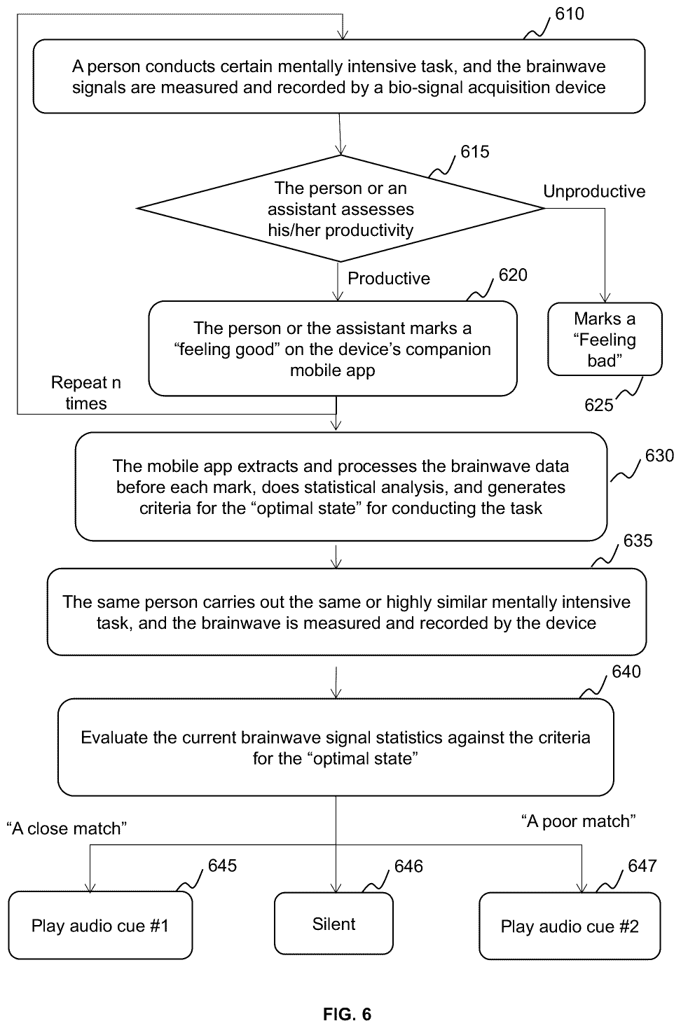

FIG. 6 is a flowchart illustrating exemplary processes for individualized performance improvement in a mentally intensive task according to some embodiments of the present disclosure. This process provides a specific example for the processes illustrated in FIGS. 2-4.

As shown in step 610 of FIG. 6, a person (as the “user” described in FIGS. 2-4) may engage in a mentally intensive task (as the “first task” described in FIG. 2-4), with brainwave signals being measured and recorded by a bio-signal acquisition device. The device is typically worn on the person's head. In some embodiments, the device is the bioelectrical signal acquisition device 20 shown in FIG. 1.

As shown in step 615, the person or an assistant may evaluate the person's productivity, which can vary based on the nature of the mentally intensive task. For example, if the mentally intensive task is solving math problems or taking an exam, the measurement of success can be whether the problem is solved or the score of the exam.

One feature of mentally intensive task is this may be a prolonged process, instead of a relatively short performance (e.g., golf shot, basketball shot, or baseball pitch). In such a prolonged process, the overall task can be segmented into sub-tasks, each or which can be used for the assessment of the user's performance and establishment of the IPI model, which can generate criteria for the “optimal state”.

As shown in steps 620 and 625, the person or the assistant may record his/her feel about his/her performance, for the entire mentally intensive task or for part of the mentally intensive task (e.g., one problem in a series of problems; or a time segment of an exam). In certain embodiments, such markings can take the form of user's pressing “feeling good” (or “hit”) or “feeling bad (or “miss”) on the bioelectrical signal acquisition device's companion mobile application. In certain embodiments, such markings can take the form of more objective forms such as whether the problem is solved or the score of the exam (or part of the exam). The process of 610, 615, 620 and 625 may be repeated n time, n being an integer greater than 1.

In certain embodiments, such marking may trigger the application to extract and process brainwave data corresponding to the shot, as shown in 630. In certain embodiments, data extraction and processing are only triggered after the number of performances has reached a threshold.

In some embodiments, the mobile application conducts statistical analysis on the brainwave data preceding each successful shot. In some embodiments, the mobile application conducts statistical analysis on the brainwave data preceding all the shots. Based on the results of either approach, the mobile application generates criteria for an “optimal state” for performing the shot. In some embodiments, the optimal state is represented by one or more parameter values or ranges for one or more target parameters. In some embodiments, the parameter values or ranges may be generated by a IPI model, as described in FIGS. 2-4.

With real-life testing, it is found that high-beta and gamma brainwaves are likely the most relevant parameters for mentally intensive tasks. Therefore, in some cases, for mentally intensive tasks, the user's signals are recorded continuously, analyzed in real-time, and often feedbacks (signals sequence) are provided to help the user to adjust his/her mental state. In certain embodiments, the user may be asked to focus more. In certain embodiments, the user may be asked to take a break to disengage so that he/she can rest and re-focus later.

As shown in step 635, the same person may carry out the same or highly similar mentally intensive task when his/her brainwave signals are measured and recorded by the bioelectrical signal acquisition device. One key feature for some of the cases shown in FIG. 6 is that such measurements and recording can take place not only before, but also during the mentally intensive task is performed, especially when such tasks take a prolonged period of time (e.g., more than 5, 10, 15, 20, 30, 60, 90, or 120 minutes). For the sport tasks shown in FIGS. 5A, 5B, and 5B, generally the relevant measurements and recordings are generated before, not during, the task is performed.

As shown in 640, the acquired signals are evaluated and compared to the criteria established earlier. Specifically, a determination is made as to whether the acquired signals, after extraction and statistical analysis, would be matched with the “optimal state”.

As shown in 645, 646, and 647, if the system determines that it is a “close match”, cue #1 (audio, visual, and/or haptic) is played; if it is a “poor match”, cue #2 (audio, visual, and/or haptic) is played. If a determination cannot be made with a high level of reliability, the system may stay passive. In some embodiments, cue #1 would urge the person to proceed with the shot; cue #2 may prompt the person to adjust his/her mental state, so that the “optimal state” can be achieved. In certain embodiments, cue #2 made include specific instructions as to how the “optimal state” might be arrived at.

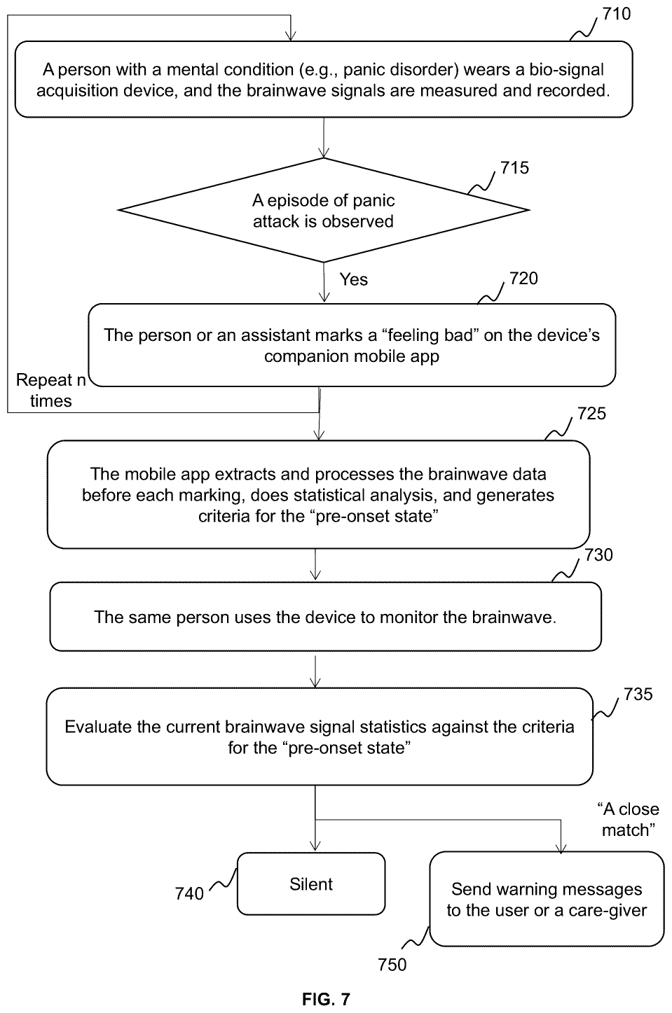

FIG. 7 is a flowchart illustrating exemplary processes for individualized performance improvement for a person with a mental condition according to some embodiments of the present disclosure. This process provides a specific example for the processes illustrated in FIGS. 2-4.

As shown in step 710 of FIG. 7, a person (as the “user” described in FIGS. 2-4) may engage in a mentally intensive task (as the “first task” described in FIG. 2-4), with brainwave signals being measured and recorded by a bio-signal acquisition device. The device is typically worn on the person's head. In some embodiments, the device is the bioelectrical signal acquisition device 20 shown in FIG. 1. For example, the person may be prone to have panic attacks and may wear the bioelectrical signal acquisition device.

In some embodiments, the person may wear the bioelectrical signal acquisition device for a long period (e.g., more than 3, 6, 12, 18, 24, 36, or 48 hours) to gather data related to an episode. In some embodiments, to reduce prolonged recording, the person may start wearing the device when there are other signs pointing to a likely episode. As shown in steps 715 and 720, the person may experience an episode of panic attack and the person or an assistant (e.g., doctor, nurse, or caregiver) may record his/her such an occurrence by marking “feeling bad (or “miss”) on the bioelectrical signal acquisition device's companion mobile application. In certain embodiments, for mental conditions of other forms, the marking may be made when specific thresholds are surpassed or events occur.

The process of 710, 715, and 720 may be repeated n time, n being an integer greater than 1.

In certain embodiments, such marking may trigger the application to extract and process brainwave data corresponding to the shot, as shown in 725. In certain embodiments, data extraction and processing are only triggered after the number of performances has reached a threshold.

In some embodiments, the mobile application conducts statistical analysis on the brainwave data preceding the incident of panic attacks. Based on the results of such analysis, the mobile application generates criteria for an “pre-onset state” for the occurrence of a panic attack. In some embodiments, the pre-onset state is represented by one or more parameter values or ranges for one or more target parameters. In some embodiments, the parameter values or ranges may be generated by a IPI model, as described in FIGS. 2-4.

As shown in step 730, the same person may use the bioelectrical signal acquisition device to measure and record his/her brainwaves. Similarly, the person may wear the device for a long period of time or start wearing the device upon other signs.

As shown in 735, the acquired signals are evaluated and compared to the criteria established earlier. Specifically, a determination is made as to whether the acquired signals, after extraction and statistical analysis, would be matched with the “pre-onset state”.

As shown in 740 and 750, if the system determines that it is a “close match”, the system may send a warning message to the person or the assistant (e.g., doctor, nurse or caregiver). Otherwise (e.g., if it is a “poor match” or “hard to determine”, the system may stay silent and person can go about his/her life. The warning message may prompt the person to adjust his/her mental state to avoid a panic attack. In certain embodiments, the warning message made include specific instructions as to how the person can avoid or switch out of the “pre-onset state”. In certain embodiments, the warning message may also include instructions to the person to seek medical assistance.

Having thus described the basic concepts, it may be rather apparent to those skilled in the art after reading this detailed disclosure that the foregoing detailed disclosure may be intended to be presented by way of example only and may be not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure. Moreover, certain terminology has been used to describe embodiments of the present disclosure. For example, the terms “one embodiment,” “an embodiment,” and/or “some embodiments” mean that a particular feature, structure or characteristic described in connection with the embodiment may be included in at least one embodiment of the present disclosure.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. Program code embodied on a computer readable signal medium may be transmitted using any appropriate medium, including wireless, wireline, optical fiber cable, RF, or the like, or any suitable combination of the foregoing.

Furthermore, the recited order of processing elements or sequences, or the use of numbers, letters, or other designations therefore, may be not intended to limit the claimed processes and methods to any order except as may be specified in the claims. Although the above disclosure discusses through various examples what may be currently considered to be a variety of useful embodiments of the disclosure, it may be to be understood that such detail may be solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped together in a single embodiment, figure, or description thereof for the purposes of streamlining the disclosure aiding in the understanding of one or more of the various inventive embodiments. This method of disclosure, however, may be not to be interpreted as reflecting an intention that the claimed user matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated.

Each of the patents, patent applications, publications of patent applications, and other material, such as articles, books, specifications, publications, documents, things, and/or the like, referenced herein may be hereby incorporated herein by this reference in its entirety for all purposes, excepting any prosecution file history associated with same, any of same that may be inconsistent with or in conflict with the present document, or any of same that may have a limiting affect as to the broadest scope of the claims now or later associated with the present document.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and describe.

I claim:

1. A method of individualized performance improvement (IPI) using an interactive system that includes a computational unit and a bioelectrical signal acquisition device, the method comprising:
(a) recording a batch of bioelectrical signals from a user's head using the bioelectrical signal acquisition device before and/or during the user performs a first task,
(b) identifying a tag associated with the batch of bioelectrical signals, wherein the tag includes a tag value corresponding to a success level of the first task;
(c) repeating steps (a) and (b) multiple times to collect multiple batches of digital bioelectrical signals and a plurality of tag values;
(d) processing the multiple batches of bioelectrical signals with the computational unit to identify at least one target parameter that has a parameter value and collect a plurality of parameter values, each tag value corresponding to a parameter value of a same performance by the user;
(e) obtaining an IPI model tailored for the user based on the plurality of tag values and the plurality of parameter values; and
(f) providing a signal sequence to the user, the signal sequence reminding the user to attempt to adjust the target parameter to a target value or a target range before performing the first task again, wherein the target value or the target range is determined by the IPI model.

2. The method of claim 1, wherein identifying the tag comprises receiving a tagging signal provided by the user with the bioelectrical signal acquisition device, and identifying the tag based on the tagging signal.

3. The method of claim 2, wherein the tagging signal includes ocular event-related potentials (o-ERPs) that are processed by the computational unit, the o-ERPs indicates the tag value.

4. The method of claim 3, wherein the o-ERPs are generated by the user voluntarily with eye blink, eye movement, or eyelid squeezing, or a combination thereof.

5. The method of claim 2, wherein the tagging signal includes a verbal signal from the user.

6. The method of claim 1, wherein identifying the tag comprises receiving a tagging signal provided by an observer other than the user, and identifying the tag based on the tagging signal.

7. The method of claim 6, wherein tagging signal includes a verbal signal from the observer.

8. The method of claim 1, wherein tagging signal includes an input at the computational unit from the user or an observer other than the user.

9. The method of claim 8, wherein input is made through an interface of an application associated with the bioelectrical signal acquisition device.

10. The method of claim 1, wherein the tag value is hit or miss, in or out, on point or not on point, or in rang or not in range, desired performance or undesired performance.

11. The method of claim 1, wherein the tag value is desired mental state, undesired mental state, calm, alerted, distracted, overthinking, mind-wandering, stressed, anxious, fatigue, bored, or excited.

12. The method of claim 1, wherein the at least one target parameter includes alpha, beta, delta, theta, or SMR (sensory-motor rhythm) activity of the user's brain.

13. The method of claim 1, wherein the at least one target parameter includes two or more of alpha, beta, delta, theta, or SMR activity of the user's brain.

14. The method of claim 1, further comprising measuring and recording current bioelectrical signals with the bioelectrical signal acquisition device before the user performs the first task again.

15. The method of claim 14, further comprising analyzing the current bioelectrical signals to obtain a current parameter value of the at least target parameter and matching the current parameter value with the target parameter value or the target parameter range of the target parameter.

16. The method of claim 1, wherein the signal sequence includes an audio signal, a visual signal, or a haptic signal, or a combination thereof.

17. The method of claim 1, wherein identifying the at least one target parameter comprises:
extracting and analyzing a plurality of candidate parameters associated with the digital bioelectrical signals, each candidate parameter has a parameter value for each performance;
selecting the target parameter from the plurality of candidate parameters based on the analysis, wherein the target parameter's parameter values demonstrate distinct distributions for different tag values.

18. A method of individualized performance improvement (IPI) using an interactive system that includes a computational unit and a bioelectrical signal acquisition device, the method comprising:
(a) measuring and recording current bioelectrical signals from a user's head with the bioelectrical signal acquisition device before and/or during the user performs a first task;
(b) analyzing the current bioelectrical signals to obtain a current parameter value of at least one target parameter; and
(c) matching the current parameter value with a target value or a target range of the target parameter, wherein the target parameter value or the target parameter range is determined by an IPI model, which is based on multiple previous performances of the first task by the same user; and
(d) upon a determination that the current parameter value does not match with the target value or the target range, providing a signal sequence to the user, the signal sequence reminding the user to attempt to adjust the target parameter to the target value or the target range before performing the first task.

19. The method of claim 18, wherein each of the multiple previous performances of the first task generates a tag value that indicates a success level of the performance and a parameter value of the target parameter, and the IPI model is based on tag values and parameter values from the multiple previous performances.

20. The method of claim 18, wherein the IPI model is a machine learning model.
